(19) United States
(12) Patent Application Publication
(10) Pub. No.: US 2012/0137279 A1
(43) Pub. Date: May 31, 2012

(54) In-Context Notification Of An Available Update Of A Computer Program

(75) Inventors: Kimberly K. Button, Rochester, MN (US); Jacob Kugel, Rochester, MN (US); Brian O. Wood, Eagan, MN (US)

(73) Assignee: INTERNATIONAL BUSINESS MACHINES CORPORATION, Armonk, NY (US)

(21) Appl. No.: 12/956,815

(22) Filed: Nov. 30, 2010

(51) Int. Cl. G06F 9/44

(52) U.S. Cl. 717/171

(57) ABSTRACT

In-context notification of an available update of a computer program, the computer program configured to present a graphical user interface (‘GUI’) that includes one or more GUI elements where in-context notification includes: receiving, by the computer program, a notification of an available update to the computer program, the notification specifying one or more presently existing GUI elements affected by the update and displaying in the GUI, for each presently existing GUI element affected by the update, proximate to the presently existing GUI element affected by the update, an update indicator.

### BACKGROUND OF THE INVENTION

1. Field of the Invention

The field of the invention is data processing, or, more specifically, methods, apparatus, and products for in-context notification of an available update of a computer program.

2. Description Of Related Art

Many computer programs—software applications, operating systems, firmware, middleware, and the like—have the ability to check for available updates, download the update, and install the update. Typically, information about the available updates is retrieved first, either at a user's request, or in the background. The user then initiates a download and install of the update.

There are often times, however, where the user continues to work with the computer program after information about available update is retrieved, and before the update is installed. During this period, the user is typically unaware of specific functions of the application that may be fixed or improved by the available update. There may be information about the available update that the user could read, but the typical user does not read documentation supplied with an update.

Typical prior art modes of advising of available updates involve email notifications or pop-ups provided by an operating system function or separate application—an application other than the application for which the update is available—that get little or no display time in front of a user. The effect of this type of update notification system is that during most of the time that a user spends interacting with an application through a user interface, the user has no indication of the available update or the functionality provided by the available update.

### SUMMARY OF THE INVENTION

Methods, apparatus, and products for in-context notification of an available update of a computer program are described in this specification. In accordance with embodiments of the present invention, the computer program for which an update is available is configured to present a graphical user interface (GUI'), with one or more GUI elements, and the in-context notification of the available update includes receiving, by the computer program, a notification of the available update to the computer program, the notification specifying one or more presently existing GUI elements affected by the update and displaying, for each presently existing GUI element affected by the update, in the GUI, proximate to the presently existing GUI element affected by the update, an update indicator.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for in-context notification of an available update of a computer program according to embodiments of the present invention.

FIG. 2 sets forth an example GUI presented by a computer program configured for in-context notification of an available update in accordance with embodiments of the present invention.

FIG. 3 sets forth a flow chart illustrating an exemplary method for in-context notification of an available update of a computer program according to embodiments of the present invention.

### DETAILED DESCRIPTION OF EXEMPLARY EMBODIMENTS

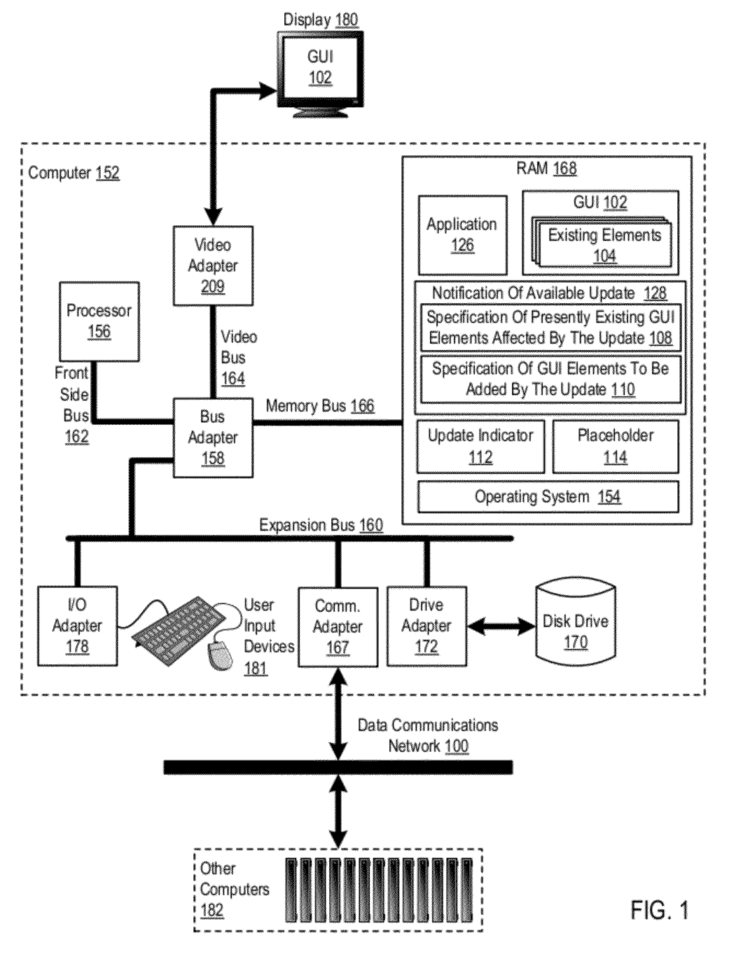

Exemplary methods, apparatus, and products for in-context notification of an available update of a computer program in accordance with embodiments of the present invention are described with reference to the accompanying drawings, beginning with FIG. 1. FIG. 1 sets forth a network diagram of a system for in-context notification of an available update of a computer program according to embodiments of the present invention. An ‘update,’ also referred to at times as a ‘patch,’ as the term is used in this specification refers to a piece of software designed to correct problems with, or upgrade functionality of a computer program or its supporting data.

The system of FIG. 1 includes a computer (152), that is, with automated computing machinery for in-context notification of an available update of a computer program in accordance with embodiments of the present invention. The example computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a software application (126), an example of a computer program for which in-context notification of an available update may be carried out in accordance with embodiments of the present invention. Examples of software applications include any application that carries out user-level data processing tasks: spreadsheet applications, word processing applications, media library applications, multimedia editing and creation applications, database management applications, browser applications and so on as will occur to readers of skill in the art

In the example of FIG. 1, the application (126) presents, on a display (180), a graphical user interface (‘GUI’) that includes one or more GUI elements (104). A GUI element refers to any component displayed in a GUI, examples of which include buttons, menus, menu items, text boxes, pop-ups, and so on as will occur to readers of skill in the art.

The application (126) in the example of FIG. 1 may be configured for in-context notification in accordance with embodiments of the present invention. That is, the application (126) may receive a notification (128) of an available update where the notification includes a specification (108) of one or more presently existing GUI elements affected by the update and, for each presently existing GUI element (104) affected by the update, the application (126) may display, in the GUI (102), proximate to the presently existing GUI element (104) affected by the update, an update indicator (112). An update indicator as the term is used in this specification refers to a graphical representation of an indication displayed in a GUI to a user. Examples of an update indicator are numerous and may include a button, an image, a text box, a text pop-up, text formatted in a particular manner (e.g. highlighted, underlined, italicized, or bolded text), and so on as will occur to reader of skill in the art. The phrase ‘proximate to’ is used here to describe a location within a GUI at which to display an update indicator—namely, near the presently existing element affected by the available update. An update indicator may be displayed proximate to the element in various ways—on or near one side of the element, interleaved with the element, as part of the element, surrounding the element, replacing the element, and so on as will occur to readers of skill in the art.

In addition to specifying presently existing GUI elements that affected by the available update, the notification (128) of the available update in the example of FIG. 1 also includes a specification (110) of one or more GUI elements to be added to the GUI by the update. In such an embodiment, the application (126) may also displaying, for each GUI element to be added, at a location in the GUI of the GUI element to be added, a placeholder (114) for the GUI element to be added. A placeholder as the term is used here is any graphical representation of a GUI element to be added. In some embodiments, a placeholder may an exact graphical duplication of a GUI element to be added without any of the GUI element-to-be-added's functionality. In an update, for example, that adds a menu to an existing set of menus, a placeholder for the menu-to-be-added may be an exact duplicate of the graphical representation of the menu-to-be-added. If a user clicks on the menu, however, menu items may not be presented. That is, the functionality of the menu-to-be-added is not available.

Also stored in RAM (168) is an operating system (154). An operating system is a computer software component that is responsible for execution of applications programs and for administration of access to computer resources, memory, processor time, and I/O functions, on behalf of application programs. Operating systems useful in-context notification of an available update of a computer program according to embodiments of the present invention include UNIX™, Linux™, Microsoft XP™, AIX™, IBM's i5/OS™, and others as will occur to those of skill in the art. In the example of FIG. 1, the operating system (154) is another example of a computer program for which in-context notification of an available update may be carried out in accordance with embodiments of the present invention. The operating system (154) and application (126) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for in-context notification of an available update of a computer program according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for in-context notification of an available update of a computer program according to embodiments of the present invention include modems for wired dial-up communications, Ethernet (IEEE 802.3) adapters for wired data communications network communications, and 802.11 adapters for wireless data communications network communications.

The arrangement of computers, networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

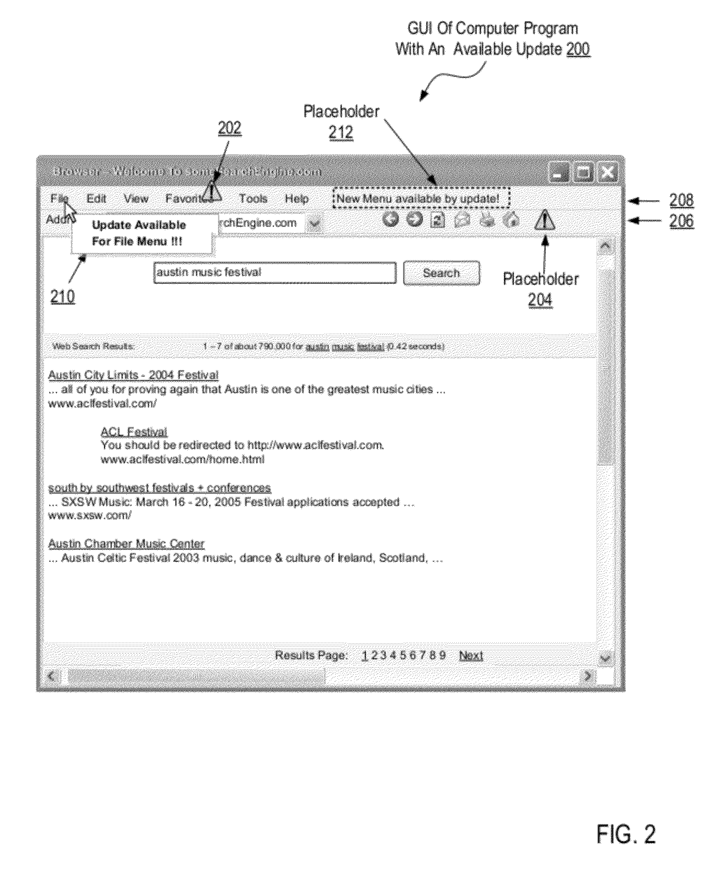

For further explanation, FIG. 2 sets forth an example GUI (200) presented by a computer program configured for in-context notification of an available update in accordance with embodiments of the present invention. The example GUI (200) in FIG. 2, is a GUI of a web browser—a module of computer program instructions (a ‘computer program’) configured for retrieving, presenting, and traversing information resources on the World Wide Web.

The web browser presenting the example GUI (200) of FIG. 2 has received a notification of an available update. The notification specifies one or more presently existing GUI elements affected by the update and one or more GUI elements to be added to the GUI by the update. In the example GUI (200) of FIG. 2, presently existing GUI elements affected by the update include the ‘Favorites’ menu in the menu bar (208), and the ‘File’ menu in the menu bar (208). For each of these presently existing GUI element affected by the update: the browser displays, in the GUI (200), proximate to the presently existing GUI element affected by the update, an update indicator. For the ‘Favorites’ menu, for example, the browser displays an update indicator (202) depicted as a warning symbol—a highlighted triangle with an exclamation mark disposed within the triangle. For the ‘File’ menu, an update indicator (210) is depicted as a pop-up (210). The browser may display the pop-up (210) on a mouse-over or hover-over of the ‘File’ menu. In this way, the update indicator (210) is displayed at a time that user interaction with an element to be updated is most probable.

Examples of GUI elements to be added to the GUI by the update include a menu in the menu bar (208) and a button in a navigation bar (206). For each of these GUI elements to be added to the GUI by the update, the browser displays, at a location in the GUI of the GUI element to be added, a placeholder for the GUI element to be added. For the menu to be added to the menu bar (208), the browser displays a placeholder (212) as a dashed box with text informing a user of the update. The placeholder (212) is displayed in a location at which the new menu will be added once the browser is updated. For the button to be added to the navigation bar (206), a placeholder (204) depicted as a warning symbol is displayed in a location at which the button will be added once the browser is updated. These are but a few examples of placeholders and update indicators in a GUI of one type of computer program. Readers of skill in the art will recognize that many possible types of placeholders and update indicators may be displayed in many different GUIs of different computer program types—each such implementation of placeholder, update indicator, GUI, and computer program is well within the scope of the present invention.

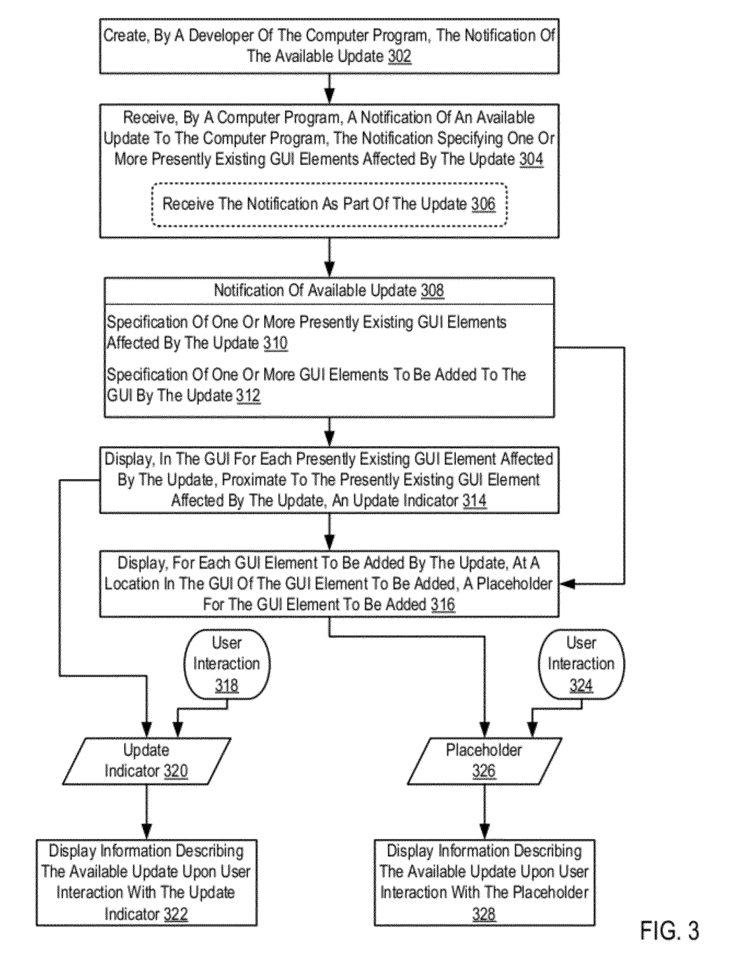

For further explanation, FIG. 3 sets forth a flow chart illustrating an exemplary method for in-context notification of an available update of a computer program according to embodiments of the present invention. The computer program for with in-context notification is carried out in accordance with the method of FIG. 3 is configured to present a GUI that includes one or more GUI elements. Computer program for which in-context notification of an available update is carried out in accordance with embodiments of the present invention include any set of computer program instructions capable of presenting a GUI—software applications, hosted web applications, operating systems, DVR (Digital Video Recorder) software running on standalone set-top-boxes, firmware such as BIOS (Basic Input/Output System), middleware, and so on as will occur to readers of skill in the art.

The method of FIG. 3 includes creating, by a developer of the computer program, a notification of an available update. In the method of FIG. 3, creating (302) a notification (308) of an available update may include specifying (310) in the notification one or more presently existing GUI elements affected by the update. In some embodiments, creating (302) the notification (308) of the available update may also include specifying (312) in the notification (308) one or more GUI elements to be added by the update. The specifications (310, 312) of GUI elements affected and to be added by the update may be implemented with GUI element identifiers—for existing GUI elements to be affected, GUI element identifier of the existing GUI element and for GUI elements to be added, GUI element identifiers of a parent GUI element within which the GUI element is to be added (a menu in a menu bar, for example).

The notification (308) may be implemented in various ways, including for example, as a message, markup document such as an XML (eXtensible Markup Language) document or HTML document, a library of computer program instructions, a resource identified by a URL (Uniform Resource Locator), and in other ways as will occur to readers of skill in the art. In some embodiments, the notification may be implemented as part of the update itself. An update, for example, may comprise a package with release notes, executables, and support files. In addition to these, or inserted in these, a developer may include the notification (308) of available update.

The method of FIG. 3 also includes receiving (304), by the computer program, a notification (308) of the available update to the computer program. In embodiments in which the notification (308) is included as part of the available update, receiving (304) the notification (308) may include receiving (306) receiving the update that includes the notification. The computer program may receive (304) the notification in various ways including, for example, by requesting the notification from a known source at the behest of a user, by requesting the notification form a known source upon a predefined period of time, receiving the notification, unrequested, from a known source, and in other ways as will occur to readers of skill in the art. In the example of FIG. 3, the notification (308) includes a specification (310) of one or more presently existing GUI elements affected by the update and a specification (312) of one or more GUI elements to be added to the GUI by the update.

The method of FIG. 3 continues by displaying (314), for each presently existing GUI element affected by the update, in the GUI, proximate to the presently existing GUI element affected by the update, an update indicator (320) and displaying (316), for each GUI element to be added to the GUI by the update, at a location in the GUI of the GUI element to be added, a placeholder (326) for the GUI element to be added.

In the method of FIG. 3, each of the update indicator (320) and the placeholder (326) may be implemented as a GUI element configured to receive user interaction and invoke an action, where the action invoked upon user interaction is to display information describing the available update. That is, upon user interaction (318, 324)—a mouse click, a hover-over, a keyboard keystroke, and the like—of either the update indicator (320) or the placeholder (326), the computer program is configured to display information describing the available update. The method of FIG. 3, therefore, continues by displaying (322) information describing the available update upon user interaction with the update indicator (320) and displaying (324) information describing the available update upon user interaction with the placeholder (326). Consider, for example, a placeholder for a button to be added to a navigation bar. Upon user interaction with the placeholder, the computer program may display a notification describing the available upon, such as a text notification stating “A button to clear cookies from the present web page will be added here when updated.”

In view of the explanations set forth above, readers will recognize that the benefits of in-context notification of an available update of a computer program according to embodiments of the present invention include:
Presenting to a user additional functionality and changes to be provided by an update, in the context in which the functionality and changes will actually be experienced or seen by the user;
Notifying the user of available updates for longer period of time in a more effective manner, promoting update of computer programs and thereby increasing stability and security of the computer programs;
And other benefits as will occur to readers of skill in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable transmission medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable transmission medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable transmission medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of in-context notification of an available update of a computer program, the computer program configured to present a graphical user interface (GUI), the GUI comprising one or more GUI elements, the method comprising:
receiving, by the computer program, a notification of an available update to the computer program, the notification specifying one or more presently existing GUI elements affected by the update; and
for each presently existing GUI element affected by the update: displaying, in the GUI, proximate to the presently existing GUI element affected by the update, an update indicator.

2. The method of claim 1, wherein the update indicator comprises a GUI element configured to receive user interaction and invoke an action, the action comprising displaying information describing the available update and the method further comprises displaying information describing the available update upon user interaction with the update indicator.

3. The method of claim 1, wherein the notification further specifies one or more GUI elements to be added to the GUI by the update, and the method further comprises:
for each GUI element to be added to the GUI by the update: displaying, at a location in the GUI of the GUI element to be added, a placeholder for the GUI element to be added.

4. The method of claim 1, wherein the placeholder comprises a GUI element configured to receive user interaction and invoke an action, and the method further comprises:
displaying information describing the available update upon user interaction with the placeholder.

5. The method of claim 1, wherein:
receiving the notification of the available update further comprises receiving the notification as part of the update.

6. The method of claim 1, wherein:
creating, by a developer of the computer program, the notification of the available update, including specifying in the notification the one or more presently existing GUI elements affected by the update.

7. An apparatus for in-context notification of an available update of a computer program, the computer program configured to present a graphical user interface (GUI), the GUI comprising one or more GUI elements, the apparatus comprising a computer processor, a computer memory operatively coupled to the computer processor, the computer memory having disposed within it computer program instructions capable, when executed by the computer processor, of causing the apparatus to carry out the steps of:
receiving, by the computer program, a notification of an available update to the computer program, the notification specifying one or more presently existing GUI elements affected by the update; and
for each presently existing GUI element affected by the update: displaying, in the GUI, proximate to the presently existing GUI element affected by the update, an update indicator.

8. The apparatus of claim 7, wherein the update indicator comprises a GUI element configured to receive user interaction and invoke an action, the action comprising displaying information describing the available update and the method further comprises displaying information describing the available update upon user interaction with the update indicator.

9. The apparatus of claim 7, wherein the notification further specifies one or more GUI elements to be added to the GUI by the update, and the apparatus further comprises computer program instructions capable, when executed by the computer processor, of causing the apparatus to carry out the step of:
for each GUI element to be added to the GUI by the update: displaying, at a location in the GUI of the GUI element to be added, a placeholder for the GUI element to be added.

10. The apparatus of claim 7, wherein the placeholder comprises a GUI element configured to receive user interaction and invoke an action, and the apparatus further comprises computer program instructions capable, when executed by the computer processor, of causing the apparatus to carry out the step of displaying information describing the available update upon user interaction with the placeholder.

11. The apparatus of claim 7, wherein:
receiving the notification of the available update further comprises receiving the notification as part of the update.

12. The apparatus of claim 7, wherein:
creating, by a developer of the computer program, the notification of the available update, including specifying in the notification the one or more presently existing GUI elements affected by the update.

13. A computer program product for in-context notification of an available update of a computer program, the computer program configured to present a graphical user interface (‘GUI’), the GUI comprising one or more GUI elements, the computer program product disposed upon a computer readable medium, the computer program product comprising computer program instructions capable, when executed, of causing a computer to carry out the steps of:
receiving, by the computer program, a notification of an available update to the computer program, the notification specifying one or more presently existing GUI elements affected by the update; and
for each presently existing GUI element affected by the update: displaying, in the GUI, proximate to the presently existing GUI element affected by the update, an update indicator.

14. The computer program product of claim 13, wherein the update indicator comprises a GUI element configured to receive user interaction and invoke an action, the action comprising displaying information describing the available update and the method further comprises displaying information describing the available update upon user interaction with the update indicator.

15. The computer program product of claim 13, wherein the notification further specifies one or more GUI elements to be added to the GUI by the update, and the computer program product further comprises computer program instructions capable, when executed, of causing the computer to carry out the step of:
for each GUI element to be added to the GUI by the update: displaying, at a location in the GUI of the GUI element to be added, a placeholder for the GUI element to be added.

16. The computer program product of claim 13, wherein the placeholder comprises a GUI element configured to receive user interaction and invoke an action, and the computer program product further comprises computer program instructions capable, when executed, of causing the computer to carry out the step of displaying information describing the available update upon user interaction with the placeholder.

17. The computer program product of claim 13, wherein:
receiving the notification of the available update further comprises receiving the notification as part of the update.

18. The computer program product of claim 13, wherein:
creating, by a developer of the computer program, the notification of the available update, including specifying in the notification the one or more presently existing GUI elements affected by the update.

19. The computer program product of claim 13 wherein the computer readable medium comprises a storage medium.

20. The computer program product of claim 13 wherein the computer readable medium comprises a transmission medium.
